(19) United States
(12) Patent Application Publication
(10) Pub. No.: US 2009/0154031 A1
(43) Pub. Date: Jun. 18, 2009

(54) DIODE SHUNTING FOR ELECTROSTATIC DISCHARGE PROTECTION IN A HARD DISK DRIVE MAGNETIC HEAD

(76) Inventors: Napoleon B. Bumanlag, Laguna (PH); Roger F. Galinggana,, JR., Laguna (PH); LLoyd Henry LI, Metro Manila (PH); Ray Nicanor Tag-At, Laguna (PH)

Correspondence Address: HITACHI C/O WAGNER BLECHER LLP, 123 WESTRIDGE DRIVE, WATSONVILLE, CA, 95076, US

(21) Appl. No.: 12/002,156

(22) Filed: Dec. 13, 2007

(51) Int. Cl. G11B 5/11

(52) U.S. Cl. 360/323

(57) ABSTRACT

The present invention provides a electrostatic discharge protection device for protecting giant magnetoresistive devices in hard disk drive from being damaged by transient current generated as a result of electrostatic discharge. Embodiments of the invention include pair of surface mount diodes that are connected back-to-back and connected to the shunting pads of a head gimbal assembly in parallel to the giant magnetoresistive device protect the giant magnetoresistive device from transient current generated by the electrostatic discharge.

### TECHNICAL FIELD

The present invention relates generally to a method and a system for manufacturing and fabricating hard drive components in a manufacturing environment, and more particularly, to providing a electrostatic protection circuit to protect magnetoresistive heads of the hard disk drive from electrostatic discharge.

### BACKGROUND ART

In general, a hard disk drive is used in many processing and computing systems, magnetic data storage devices, such as disk drives are utilized for storing data. A typical disk drive includes a spindle motor having a rotor for rotating one or more data disks having data storage surfaces, and an actuator for moving a head carrier arm that supports transducer (read/write) heads, radially across the data disks to write data to or read data from concentric data tracks on the data disk.

In the manufacturing of the disk drive, many components with high electrical sensitivities are fabricated and manufactured. Devices such as the heads, sliders, etc., have electrical sensitivities to electromagnetic interferences or electrostatic discharge that requires the manufacturing environment worker to exercise great caution in the manufacturing of these components. Components such as suspensions comprise of conductive materials which tend to have conductive traces that are typically supported by insulative materials to help reduce the potential for electrostatic discharge or electromagnetic interference. When the suspension or similar components come into contact with each other.

The suspension assembly which includes the slider in many conventional system uses magnetoresistive (MR) technology. Typically the slider includes a merged head. Thus the MR head is part of the merged head that also includes a write head. The MR head further includes a sensor. The sensor is generally used for retrieving magnetically encoded information stored on the disks in the drive.

These MR sensors are particularly sensitive to electrostatic discharge (ESD) and electrical overstress (EOS) during both manufacturing, particularly during testing, and use of the magnetic head. The sensitivity to electrical damage is particularly severe for MR sensors because of the relatively small physical size. The discharge of only a few volts through such a physically small resistor is sufficient to produce currents capable of severely damaging the MR sensor.

A common solution to the problem of ESD and EOS on magnetic heads to protect the devices from direct ESD by applying shunting at the head gimbal assembly level. This shorted the terminals of the MR sensors inhibiting transient current flow to the head. The conventional shunting solution required using wires, normally gold wires, for shunting.

This conventional solution has the drawback of having to remove the shunting wires during testing or final assembly which exposes the MR device to ESD and thereby damaging the heads. Furthermore, the gold wires are typically very costly and unreliable.

Therefore, what is need is a flexible way of MR component fabrication and manufacturing that particulates and other contaminants permits to be controllably dissipated from the materials used in the construction of these MR components such that the potential damage from electrostatic discharge or electromagnetic interference to electric components particularly the MR head sensors connected to such components is reduced.

### SUMMARY

In accordance with certain aspects of the present invention, there is provided a system and method for providing electrostatic discharge protection to magnetoresistive (MR) heads in a head gimbal assembly in the fabrication and manufacture of hard disk drives.

Embodiments of the present invention include an electrostatic discharge protection circuit comprising two rectifying elements that are parallelly coupled to the terminals of the MR device to provide a conductive path for discharging transient current that may be present or accumulate at any of the two terminals of the MR devices.

In one embodiment of the electrostatic discharge prevention circuit the electrostatic discharge prevention rectifiers are coupled in reverse order but parallel to the MR terminals in order to raise the electrostatic discharge threshold of the MR devices. This results in a reduced ESD failure rate in the MR device.

In one embodiment, a surface-mount rectifiers is provided to provide protection to the MR device during a manufacturing testing process thereby preventing the shunting protection to the MR device from being removed during the testing process.

### BRIEF DESCRIPTION OF THE DRAWINGS

The accompanying drawings, which are incorporated in and constitute a part of the specification, illustrate embodiments of the invention, and together with the general description given above and the detailed description given below serve to explain the teachings of the invention.

FIG. 1 is a plan view of an HDD in accordance with one embodiment of the present invention.

FIG. 2 is a plane view illustration of a conventional method of protecting magnetoresistives devices from electrostatic discharge.

FIG. 3 is a plan view of one embodiment of the head gimbal assembly with the surface-mount diodes of one embodiment of the present invention.

FIG. 4 is a schematic diagram of one embodiment of the electrostatic discharge device in accordance with one embodiment of the present invention.

FIG. 5A is a schematic of one embodiment of the ESD prevention circuit illustrating a ESD event at the first of the giant magnetoresistive device according to one embodiment of the present invention.

FIG. 5B is a schematic of one embodiment of the ESD prevention circuit illustrating a ESD event at the second terminal of the giant magnetoresistive device according to one embodiment of the present invention.

FIG. 6 is a graph illustrating the normal voltage characteristics of the diodes of the ESD prevention circuit according to one embodiment of the present invention.

FIG. 7 is graph illustrating the GMR current with respect to the GMR device discharge voltage according to one embodiment of the present invention.

FIG. 8 is a graph illustrating the GMR current relative to the diode current with respect to the MM discharge voltage in accordance to one embodiment of the present invention.

### BEST MODES FOR CARRYING OUT THE INVENTION

Reference will now be made in detail to the alternative embodiment(s) of the present invention. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

The discussion will begin with an overview of a hard disk drive and components connected therewith. The discussion will then focus on embodiments of a method and system for protecting magnetoresistive devices from electrostatic discharge damage during the manufacturing of the hard disk drive in a disk drive assembly environment.

### Overview

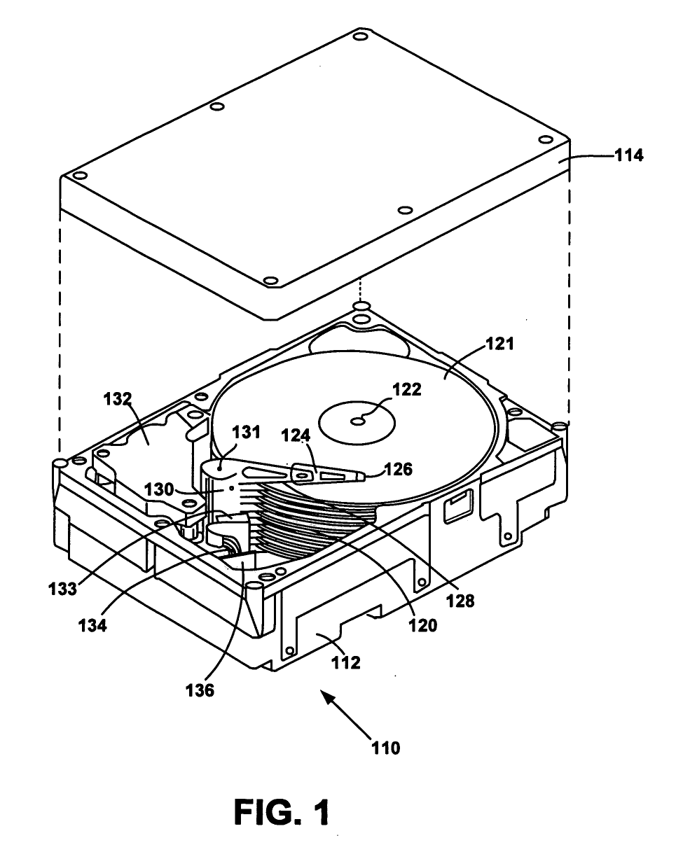

In general, the HDD comb (also referred to as an E-block) serves as a platform on which the suspensions (compliant members containing sliders with recording heads) are mounted. The recording heads fly at a constant height (on the order of nanometers) above the disk surface tracking pre-written servo information. An HDD carriage assembly (as shown in FIG. 1) forms the primary motive mechanical system that enables a disk-drive to randomly access data to be written or recorded on the disk surfaces.

With reference now to FIG. 1 shows a disk drive system designated by the general reference number 100. The cover 110 of the disk drive 100 is shown exploded. In operation, the cover 110 would be disposed on top of the housing 120. The disk drive 100 comprises one or more magnetic disks 140. The disks 140 may be conventional particulate or thin film recording disks, which are capable of storing digital data in concentric tracks. In one embodiment, both sides of the disks 140 are available for storage, and it will be recognized by one of ordinary skill in the art that the disks drive 100 may include any number of such disks 140.

The disks 140 are mounted to a spindle 150. The spindle 150 is attached to a spindle motor which rotates the spindle 150 and the disks 140 to provide read/write access to the various portions of the concentric tracks on the disks 140.

An actuator assembly 160 includes a positioner arm 128 and a suspension assembly 180. The suspension assembly 180 includes a slider assembly 190 at its distal end. Although only one slider assembly 180 is shown, it will be recognized by one skilled in the relevant art the disk drive 100 could have one slider assembly 190 for each positioner arm 170. The positioner arm 128 further comprises a pivot 131 around which the positioner arm 128 pivots.

The disk drive 100 further includes a amplifier chip 133. As is well known in the art, the amplifier chip 133 cooperates with the slider assembly on the slider assembly 126 to read data from or write data to the disks 121. The main function of the actuator assembly 130 is to move the positioner arm 128 around the pivot 131.

During manufacturing of the disk drive 100, particulates such as dust and other accumulate in the housing which need to be evacuated either prior to the sealing of the cover 110 to the housing or after the cover has been sealed to the housing.

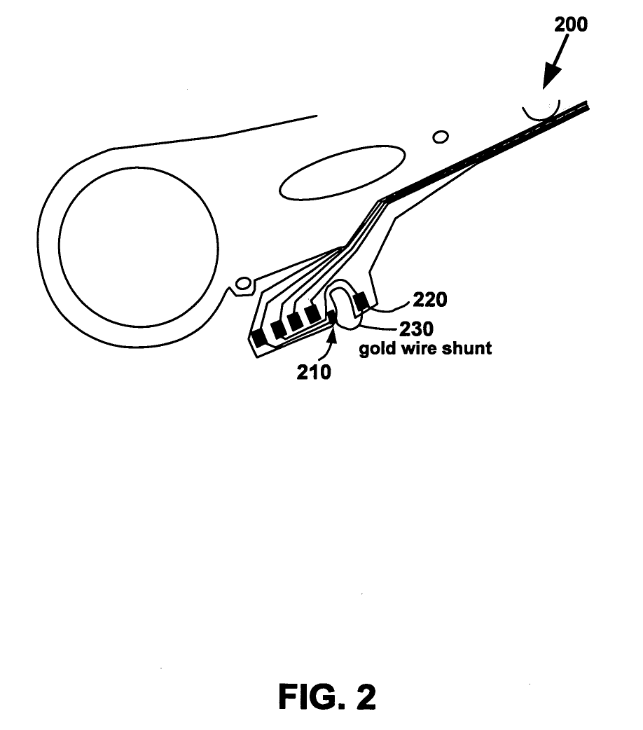

With reference now to FIG. 2 is shown an exemplary plan view of a conventional device and method of shunting the MR terminals to prevent ESD events at the terminals. As shown in FIG. 2, a bonding wire 230, preferably gold wire, is connected to terminals 210 and 220 to short the terminals.

Once current, such as ESD transients, occur at either of terminals 210 or 220, it will be shorted out and the current is prevented from flowing to the MR. At short circuit, the current is zero.

During testing of the HGA, the bonding wire 230 is removed from the terminals 210 and 220 to enable the testing equipment to properly fit and test the MR device. Removal of the wire bond 230 results in latent failures of the MR device due to the presence of ESD transients either by the operator touching the HGA or the electrostatic interference by the test equipment. To prevent the occurrence of ESD at any of terminals 210 and 220, the bonding wire 230 must be retained during the entire testing process. However, the current conventional method does not make this possible and therefore create the inevitability of the MR devices shorting out and being damaged.

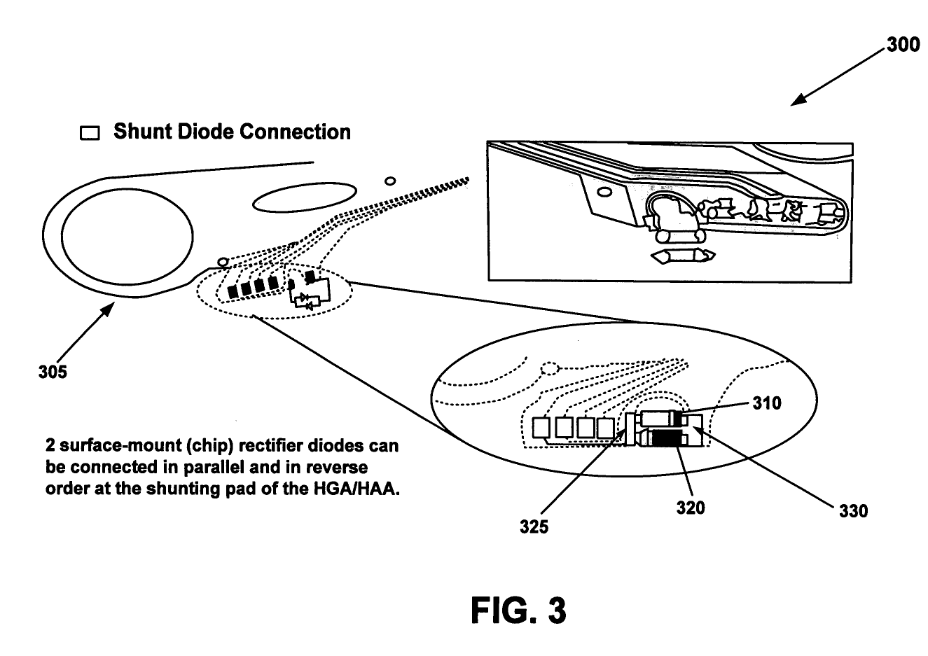

FIG. 3 is a plan view illustrating one embodiment of the ESD protection device of the present invention. As shown in FIG. 3, the ESD protection 300 of the present invention comprises coupling rectifiers 310 and 320 to the shunting pads 330 of the HGA 305. In one embodiment, the rectifiers 310 and 320 are surface-mounts that are connected back-to-back and in parallel but in reverse order with the terminals of the MR device 305. In one embodiment, the rectifiers 310 and 320 are

In one embodiment, the rectifiers 310 and 320 act as conductors at forward bias or when the voltage breakdown of the rectifiers 301 and 320 is reached at reverse bias. If the two rectifiers 310 and 320 are connected in parallel and in reverse order to the read terminal of the MR device 305, it acts as an ESD protection to both MR terminals 315 and 325.

When higher ESD occurs at the MR terminals 315 and 325 that is enough to turn “On” the rectifiers 310 and 320 (either rectifiers at forward bias), it acts as a conductor and shunt shorts the MR terminals 315 and 325. In this case, the ESD transient will flow into the rectifiers and will not pass through the MR device 305. The rectifiers 310 and 320 may be diodes.

In one embodiment, the rectifiers could also provide protection to the MR terminals 315 and 325 if there is a sudden voltage surge from testers that may cause electrical overstress (EOS).

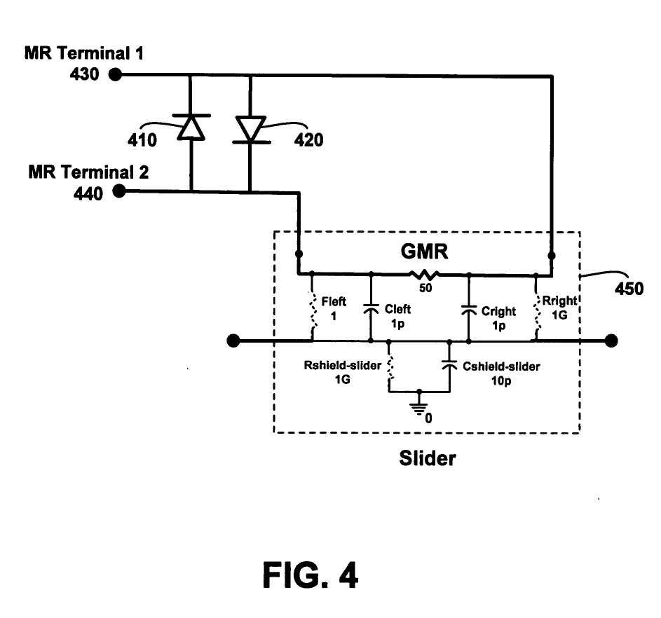

FIG. 4 is a schematic diagram illustrating one embodiment of the ESD protection circuit of the present invention. As shown in FIG. 4, the ESD protection circuit comprises a first diode 410 and a second diode 420. The diodes 410 and 420 are connected to the shunting pads of the HGS to protect the MR terminals 430 and 440.

In one embodiment the diodes 410 and 420 are connected in parallel to the terminals 430 and 440. As a ESD event occurs at either terminal 430 or 440, the diodes 410 and 420 is each capable of being turned “On” to shunt short the terminals 430 and 440 to the GMR 450.

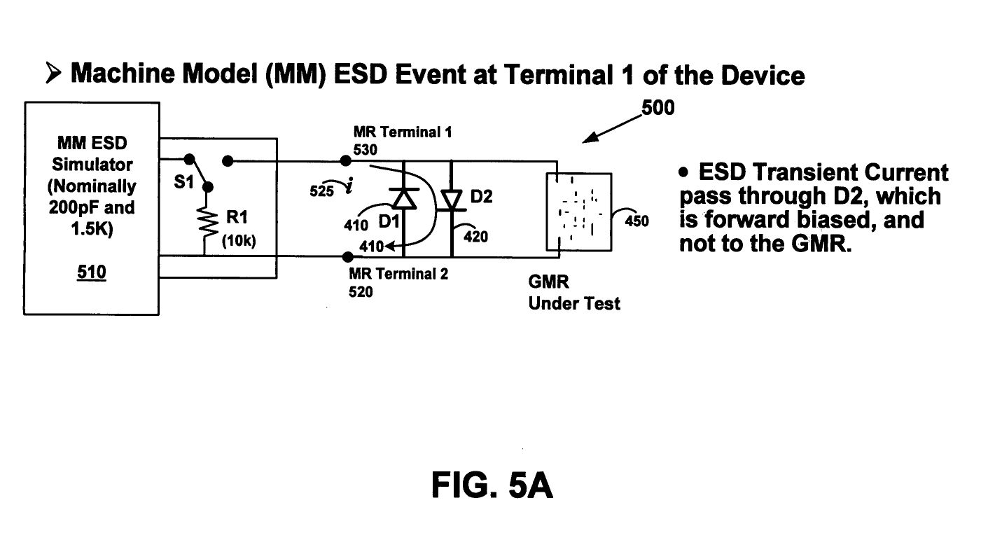

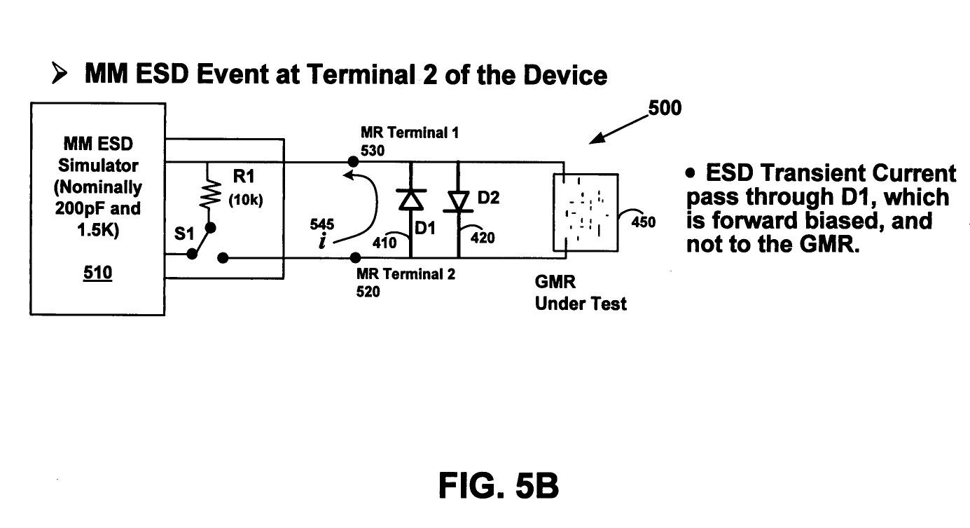

FIGS. 5A and 5B are schematic diagrams illustrating one embodiment of the rectifiers 410 and 420 reaction to ESD transient current. In FIG. 5A, an exemplary schematic diagram of the GMR device 450 under test is illustrated. As shown in FIG. 5A, the GMR 450 is connected to the ESD protection diode at terminals 1 and 2. The GMR 450 is then coupled to a machine model (MM) ESD event simulator 520 to simulate a ESD transient current 525. As the ESD transient current 525 passes through diode D2 420 which is forward biased, the current (i) 525 passes through diode D2 420 and not to the GMR 450 and thereby preventing any damage to the GMR 450.

Similarly, in FIG. 5B, the ESD transient current (i) 545 passes through diode D1 410 which is also forward biased and does not reach the GMR 450. High magnitude ESD transient current can occur at either terminals MR1 510 or MR2 520 of the GMR 450. The ESD transient current 545 will flow to either diodes with the forward bias condition and thus protect the GMR 450.

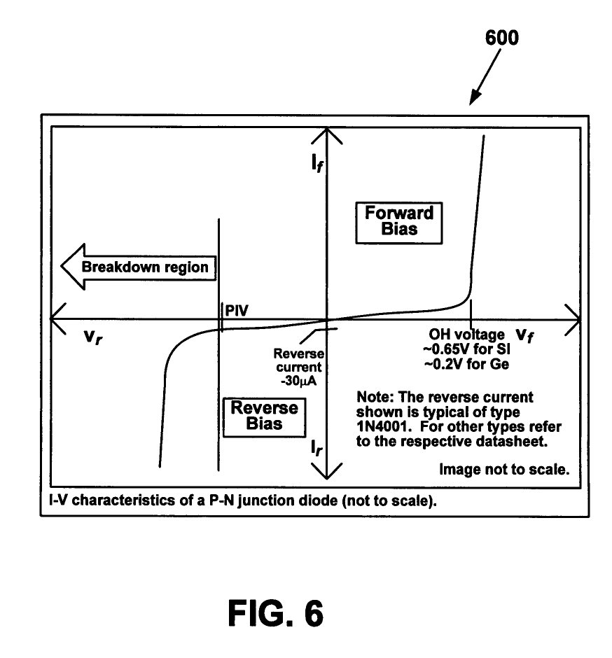

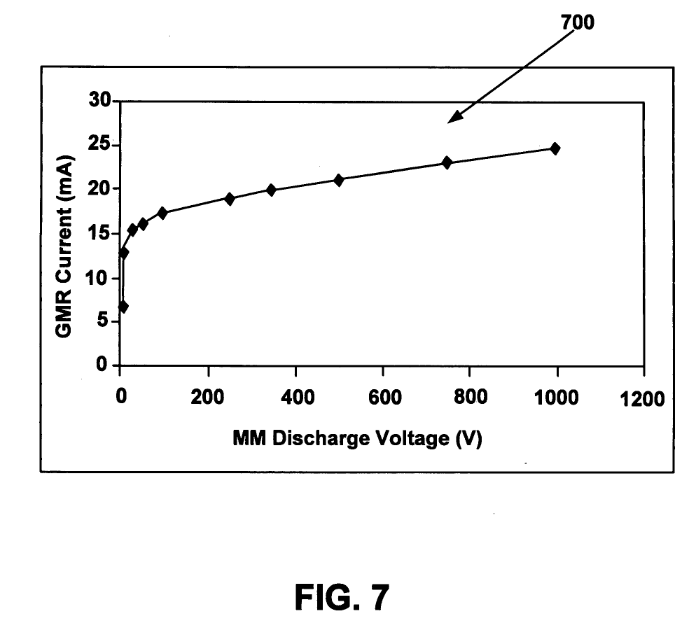

FIG. 6 is a graph illustrating the operation of the ESD protection device 400. As illustrated in FIG. 7, the amount of current through the diodes of the ESD protection device 400 as a function of the forward or reverse voltage across the MR terminals. In normal operating mode, the diodes have typically forward bias voltage of 0.65V (Ge) and 0.2V (Si) and the reverse bias voltage is 50V (at normal temperature).

Thus, by diverting ESD transients greater than 0.2V-0.65V, the diodes act as conductors and will shunt short the MR terminals enabling current to flow to the diodes instead of the GMR.

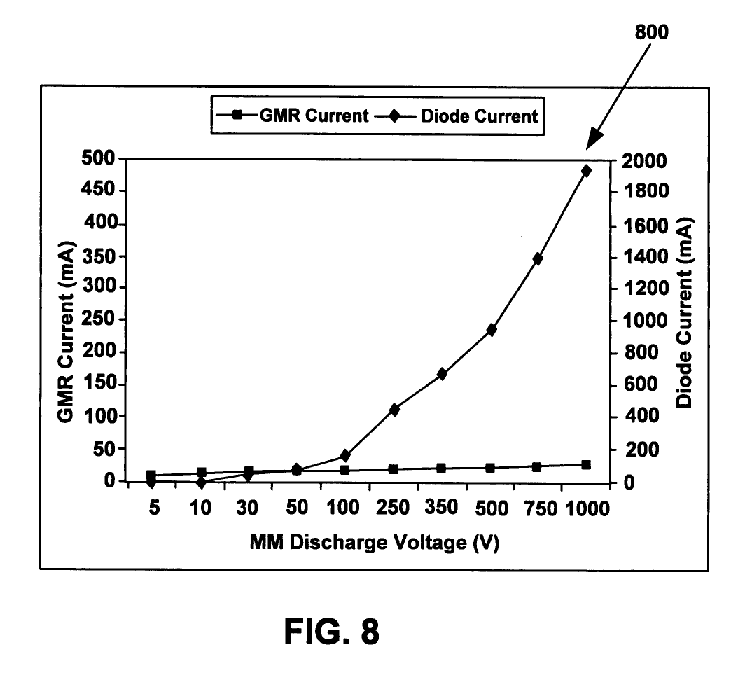

FIG. 7 is a graph illustrating the GMR current relative to the transient discharge voltage. As illustrated in FIG. 8, a threshold current of 25 mA is the most that the GMR could handle. Thus, regardless of the magnitude of the discharge voltage, the current that will flow to the GMR is maintained at a minimal and tolerable level.

FIG. 8 is a graph illustrating the GMR current relative to the diode current with respect to any transient discharge voltage. As shown in FIG. 9, once the dido is turned on, it permits flow of transient current. With the diode current reaching as high as 200 mA and the corresponding GMR current being just under 200 mA with the transient current voltage ranging between 5V an 950V. Current to the diode means that the GMR is bypassed and protected from high magnitude transient current

Example embodiments of the present technology are thus described. Although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A hard disk drive having a electrostatic discharge prevention device for preventing electrostatic discharge in a gain magnetoresistive head in a head gimbal assembly, the hard disk drive comprising:
a giant magnetoresistive head coupled to a head gimbal assembly, the giant magnetoresistive head having a first and a second terminal; and
a electrostatic discharge prevention device having a pair of surface-mount rectifiers connected back-to-back and coupled in parallel to the first and the second terminals of the giant magnetoresistive head at shunting pads of the head gimbal assembly.

2. The hard disk drive of claim 1, wherein the pair of surface-mount rectifiers are diodes.

3. The hard disk drive of claim 2, wherein the diodes are coupled in reverse order to the current flow to the first and the second terminals of the giant magnetoresistive head.

4. The hard disk drive of claim 3, wherein when either one of the pair of diodes is turned on by an occurrence of a high electrostatic discharge of the pair of diodes act as a conductive path to shunt short the first and the second terminals of the giant magnetoresistive head.

5. The hard disk drive of claim 4, wherein the pair of diodes further provide protection to either of the first and the second terminals of the giant magnetoresistive head in the event of a sudden voltage surge at either of the first and the second terminals as a result of electrical overstress.

6. The hard disk drive of claim 5, wherein the shunt short inhibits transient current to flow to the giant magnetoresistive head.

7. The hard disk drive of claim 6, wherein the diodes are of similar capacitance.

8. The hard disk drive of claim 7, wherein the transient current is within a range of 0.2 volts to 0.65 volts.

9. A head gimbal assembly having a electrostatic discharge prevention device for preventing electrostatic discharge in a giant magnetoresistive head, the head gimbal assembly comprising:
a giant magnetoresistive head, the giant magnetoresistive head having a first and a second terminal;
shunting pads; and
a electrostatic discharge prevention device having a pair of surface-mount rectifiers connected back-to-back and coupled in parallel to the first and the second terminals of the giant magnetoresistive head at the shunting pads.

10. The head gimbal assembly of claim 9, wherein the pair of surface-mount rectifiers are diodes.

11. The head gimbal assembly of claim 10, wherein the diodes are coupled in reverse order to the current flow to the first and the second terminals of the giant magnetoresistive head.

12. The head gimbal assembly of claim 11, wherein when either one of the pair of diodes is turned on by an occurrence of a high electrostatic discharge of the pair of diodes act as a conductive path to shunt short the first and the second terminals of the giant magnetoresistive head

13. The head gimbal assembly of claim 12, wherein the pair of diodes further provide protection to either of the first and the second terminals of the giant magnetoresistive head in the event of a sudden voltage surge at either of the first and the second terminals as a result of electrical overstress.

14. The head gimbal assembly of claim 13, wherein the pair of diodes further provide protection to either of the first and the second terminals of the giant magnetoresistive head in the event of a sudden voltage surge at either of the first and the second terminals as a result of electrical overstress.

15. The head gimbal assembly of claim 14, wherein the shunt short inhibits transient current to flow to the giant magnetoresistive head.

16. A method of protecting a giant magnetoresistive head in a hard disk drive from electrostatic discharge damage, the method comprising:
providing electrostatic discharge protection device having a pair of surface-mount rectifiers connected back-to-back and coupled in parallel to the first and the second terminals of the giant magnetoresistive head at shunting pads of a head gimbal assembly of the hard disk drive.

17. The method of claim 16, wherein. The pair of surface-mount rectifers are of similar capacitance.
